(19) United States
(12) Patent Application Publication
(10) Pub. No.: US 2004/0152415 A1
(43) Pub. Date: Aug. 5, 2004

(54) Active antenna method and system with variable directivity and gain

(76) Inventor: Themi Anagnos, La Grange Park, IL (US)

Correspondence Address: THEMI ANAGNOS, 437 N. ASHLAND AVENUE, LA GRANGE PARK, IL, 60526, US

(21) Appl. No.: 10/356,936

(22) Filed: Feb. 1, 2003

(51) Int. Cl. H04B 7/14

(52) U.S. Cl. 455/25; 455/226.1

(57) ABSTRACT

A wireless mobile communication system comprising a variable beam antenna system having a beam width and a direction; a variable beam antenna controller for controlling the beam width and direction of the variable beam antenna system and for receiving a communication link quality indication; and a predetermined trigger for measuring the communication link quality indication in at least one beam width position and positioning the beam width in a direction corresponding with a maximum communication link quality. The active, variable gain antenna system has the ability to compensate for deep-fades inside a building. Typically, the primary cause for dropped-calls inside buildings is due to deep fades inside buildings.

### FIELD

The field of the invention relates to wireless communications, and more particularly to active antennas in wireless communications.

### BACKGROUND

Wireless communication systems are known to employ generally two types of fixed beam radiation pattern antenna systems. Omni directional antennas transmit and receive radially in a circular pattern relative to the antenna along the surface of the earth. Conventional directional, or sector antennas radiate within a sector or region such as in a 60 degree or 120 degree sector from the antenna along the surface of the earth. The radiation pattern of a directional antenna appears as an elongated parabolic shape and typically has a 120 or 60 degree beam width at the 3 dB points. However, wireless communication systems that use these fixed beam radiation pattern antennas radiate energy in the entire cell coverage pattern or sector in order to provide communications to a mobile unit. As a result, energy is radiated to other parts of the communication system causing interference with other base stations and mobile units. As a result, the interference caused in the system reduces the capacity and the coverage of the communication system. Therefore, an antenna system is needed for reducing interference in the communication system.

### SUMMARY

A wireless mobile communication system comprising a variable beam antenna system having a beam width and a direction; a variable beam antenna controller for controlling the beam width and direction of the variable beam antenna system and for receiving a communication link quality indication; and a predetermined trigger for measuring the communication link quality indication in at least one beam width position and positioning the beam width in a direction corresponding with a maximum communication link quality. The active, variable gain antenna system has the ability to compensate for deep-fades inside a building. Typically, the primary cause for dropped-calls inside buildings is due to deep fades inside buildings.

### BRIEF DESCRIPTION OF THE DRAWINGS

These and other features, aspects, and advantages of the present invention will become better understood with regard to the following description, appended claims, and accompanying drawings where:

FIG. 1 is a block diagram for an active antenna system 10;

FIG. 2 is a block diagram showing interfaces for the hybrid fixed and variable receive and transmit antennas;

FIG. 3 is a block diagram showing the receive antenna and transmit antenna along with their interfaces;

FIG. 4 is a schematic diagram of a switch matrix;

FIG. 5 is a received signal power graph over time illustrating the transition between the fixed antennas and the variable antennas in the hybrid fixed-variable antenna system;

FIG. 6 illustrates the method of tracking a mobile user traveling into a tunnel 84 and experiencing a deep fade;

FIG. 7a illustrates in one exemplary embodiment, a hybrid variable and fixed antenna system by adding a variable antenna in a three-sided configuration to a fixed directional antenna system;

FIG. 7b illustrates in one exemplary embodiment, a hybrid variable and fixed antenna system by adding a variable antenna in a three sided configuration to a fixed omni directional antenna system;

FIG. 8 illustrates in one exemplary embodiment, the method of tracking a mobile user traveling within a building and experiencing a deep fade;

FIG. 9 illustrates another method of tracking a mobile user;

FIG. 10 is a flow chart illustrating the method for adapting the beam width, antenna gain, and the directivity of the variable antenna; and

FIGS. 11a, 11b, 11c are examples of beam direction finding.

### DETAILED DESCRIPTION OF THE INVENTION

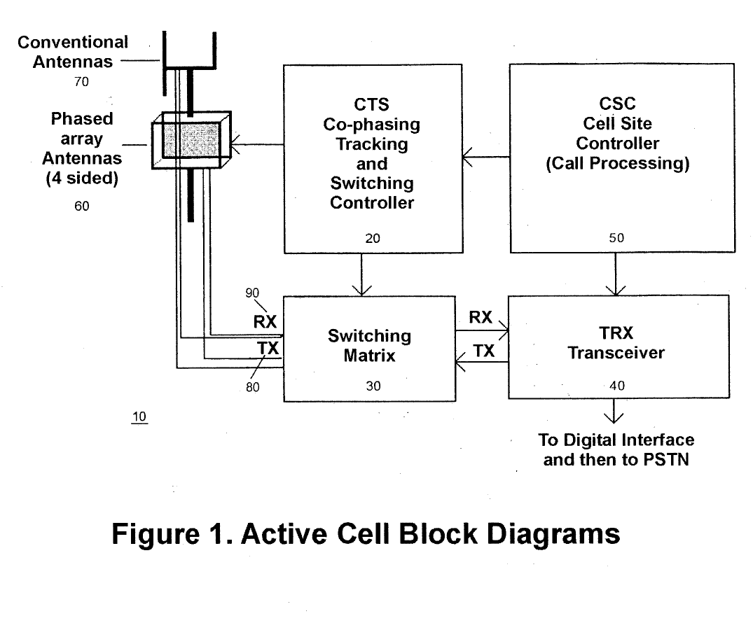

FIG. 1 is a block diagram for an active antenna system 10. The active antenna system 10 has a tracking and switching controller 20, switching matrix 30, transceiver 40, cell site controller 50, variable beam antenna system 60, and fixed beam antennas 70. Antennas 60 and 70 communicate with a mobile user. In one embodiment, the variable beam antenna system 60 supplement fixed beam antennas 70 in a hybrid antenna configuration. In another embodiment, the active antenna system 10 of FIG. 1 communicates with one or more mobile users using the variable beam antennas 60. The active, variable gain antenna system 10 has the ability to compensate for deep-fades inside a building. Typically, the primary cause for dropped-calls inside buildings is due to deep fades inside buildings.

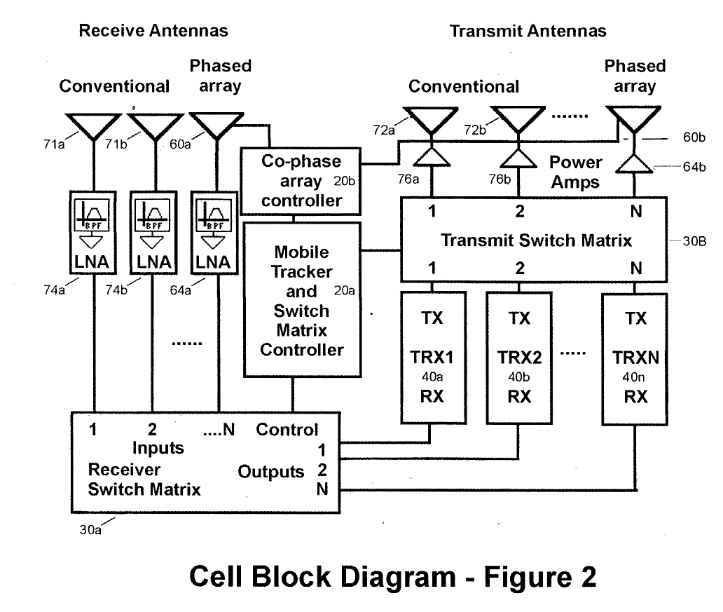

FIG. 2 is a block diagram showing the active antenna system 10 for the hybrid antenna configuration in more detail. Fixed receive antennas 71a, 71b, and variable beam antennas 60a are coupled to LNA and BPF (Band Pass Filter) 74a, 74b, 64a respectively. LNA and BPF (Band Pass Filter) 74a, 74b, 64a are coupled to receiver switch matrix 30a. The receiver switch matrix 30a is coupled to the receive inputs of transceivers 40a, 40b, and 40n. Transceivers 40a, 40b, and 40n are coupled to power amplifiers 76a, 76b, 64b. Power amplifiers 76a, 76b, 64b are coupled to fixed beam antennas 72a, 72b and variable beam antennas 60b. The variable beam antennas 60a, 60b have their beam width, gain and direction controlled by controller 20b. Mobile tracker and switch controller 20a controls receiver switch matrix 30A and transmit switch matrix 30b.

The co-phasing, mobile tracking, and switching controller 20a, 20b is shown in FIG. 2. Connections, routings, handovers, tracking management, and capacity management are controlled by controller 20a, 20b. Since the base station can adapt to different conditions, controllers 20a, 20b re-configure the antenna's variable radiation pattern to correspond to the varying demands of the system.

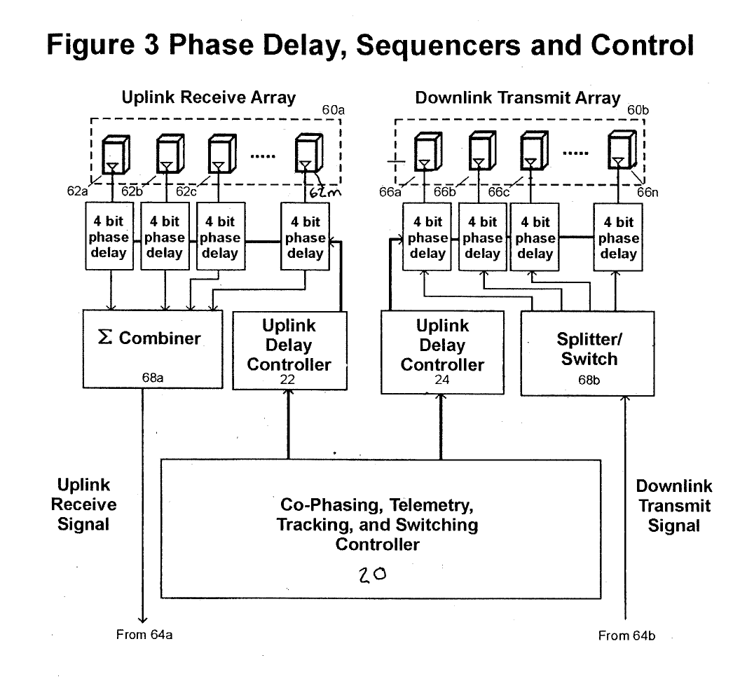

FIG. 3 is a block diagram showing the receive antenna 60a and transmit antenna 60b from FIG. 2 along with their interfaces in more detail. Receive antenna 60a, elements 62a, 62b, 62c, 62m are coupled to corresponding phase delay elements controlled by uplink delay controller 22. The receive signals from receive elements 62, 62b, 62c of the receive antenna 60a are combined into combiner 68a and the resulting combined signal is fed to LNA/BPF 64a. The transmit signals (from power amplifiers 76a, 76b, 64b) are fed to splitter/switch matrix 68b. The appropriate transmit signals are routed from splitter/switch matrix 68b to phase delay elements and their corresponding variable transmit antenna elements 66a, 66b, 66c, 66n.

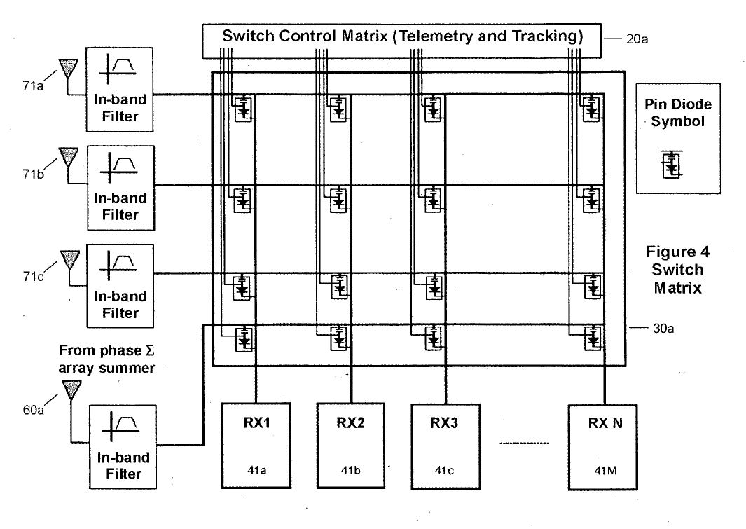

FIG. 4 is a schematic diagram of switch matrix 30a of FIG. 2 in more detail. Fixed receive antennas 71a, 71b, 71c, and variable receive antenna 60a are coupled to switch matrix 30a. The switch matrix 30a is controlled by mobile tracker and switch controller 20a. The receive signals from the switch matrix 30a then feeds the receivers 41a, 41b, 41c, 41m from transceivers 40a, 40b, 40n.

FIG. 4 shows the switching matrix placed between the antennas 71a, 71b, 71c, 60a and the receivers 41a, 41b, 41c, 41m. The switch matrix 30a allows continuous communication with the mobile. Communication is maintained during the switch or handover between the conventional fixed gain antenna and the active phased array antenna and visa versa. Any antenna input is switchable to any transceiver 41a, 41b, 41c, 41m to facilitate the switch or handover between fixed and variable gain antennas 60, 70. Although FIG. 4 illustrates a receive switch matrix 30a, a transmit switch matrix 30b may similarly be implemented to switch the transmit path. In one embodiment, the transmit switching matrix 30b can be implemented at the base band level. The switching element of the switch matrix 30a, 30b is a pin diode, which provides a connection between the two points of contact when the pin diode is forward biased. The connection is broken when the pin diode is reversed biased. A control line from the switch control matrix biases the pin diode as needed. Other devices may be implemented for switching elements.

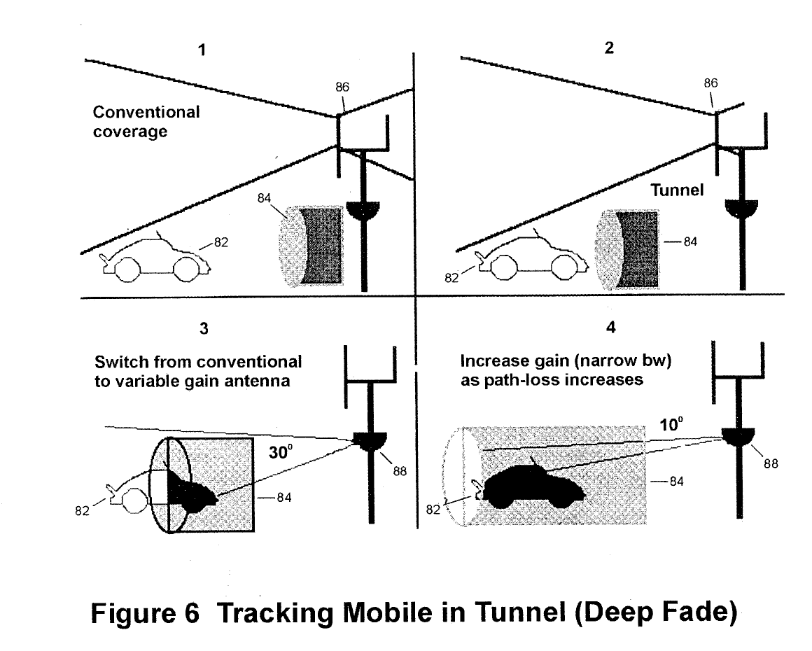

FIG. 6 illustrates the method of tracking a mobile user traveling into a tunnel 84 and experiencing a deep fade. The mobile 82 shown in FIG. 6 is served by the fixed antenna 86 as the mobile 82 experiences a deep fade resulting in the path loss exceeding the maximum path loss for the fixed antenna. The mobile 82 is switched to the active antenna 88 with a wide beam width initially for acquisition of the mobile signal. The active antenna system 10 may then increase the gain of the active antenna 88 in order to compensate for the increased path-loss caused by the mobile 82 entering the tunnel 82. The beamwidth angles in FIG. 6 are chosen for illustrative purposes and other beamwidth angels may be chosen such as 1 degree through 180 degrees. The exact beamwidth angle would depend on the antenna gain required, the location of the mobile, 82, and the actual path loss encountered.

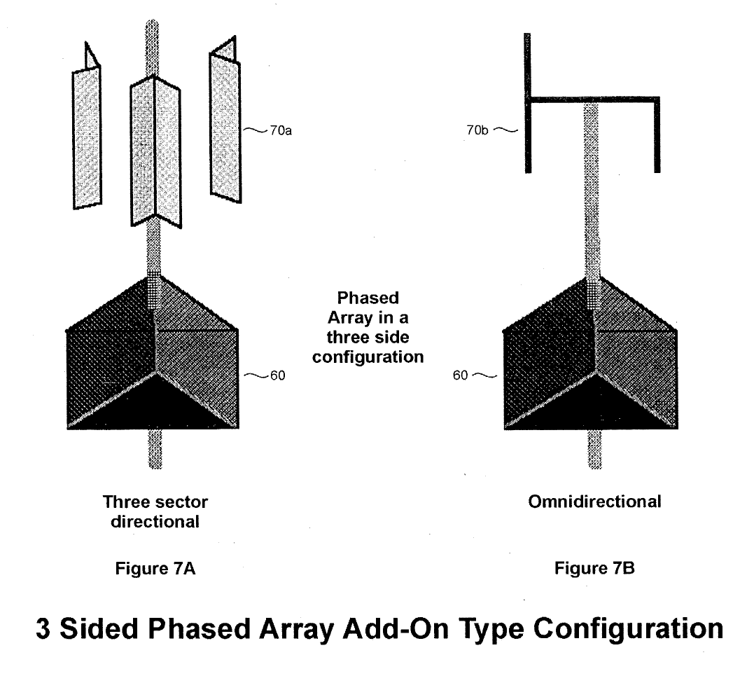

FIG. 7a illustrates in one exemplary embodiment, a hybrid variable and fixed gain antenna system by adding a variable antenna 60 in a three-sided configuration to a fixed directional antenna system 70a. FIG. 7b illustrates in one exemplary embodiment, a hybrid variable gain and fixed gain antenna system by adding a variable gain antenna 60 in a three-sided configuration to a fixed gain omni directional antenna system 70b. Although the variable gain antenna system is shown in a three-sided configuration, the variable gain antenna may take any shape such as round, elliptic, or any polygon of any number of sides. The number of elements depends on the coverage and capacity requirements of the service area.

Phased Array

In one embodiment, the active receive and transmit antenna system 60a, 60b and method as shown in FIG. 3 may be implemented using a phased array. Alternatively, the active antenna system may be a fixed array of fixed gain antennas for providing a similar function as the phased array. In one embodiment, the antenna elements 62a, 62b, 62c, 62m, 66a, 66b, 66c, 66m are antenna horns in a phased array antenna system although other shapes such as bow-ties, triangles, diamonds, and fractals may be used. The phase delay elements for each antenna horn is independently controlled using the combinations of 4 transmission delay elements per antenna for providing 16(2\hat{ }4)=256 phase delay positions. Greater or fewer numbers of delay elements and delay positions may be used. Each phase delay element 62a, 62b, 62c, 62m, 66a, 66b, 66c, 66m is controlled by a sequencer 22, 24 for adjusting the phase delay in a non-linear linear progression for each of the 16 phased delay positions. The sequencer 22, 24 adjusts the delay elements 62a, 62b, 62c, 62m, 66a, 66b, 66c, 66m in order to form a beam of a desired beam width and direction.

As the number of phased array elements 62a, 62b, 62c, 62m, 66a, 66b, 66c, 66m are increased, the coverage and capacity of the active antenna system 10 increases. The coverage is increased because the higher gain antennas can penetrate calls farther and deeper within a structure such as a building, tunnel, underground structure, and vehicle. The capacity is increased because more calls may be served.

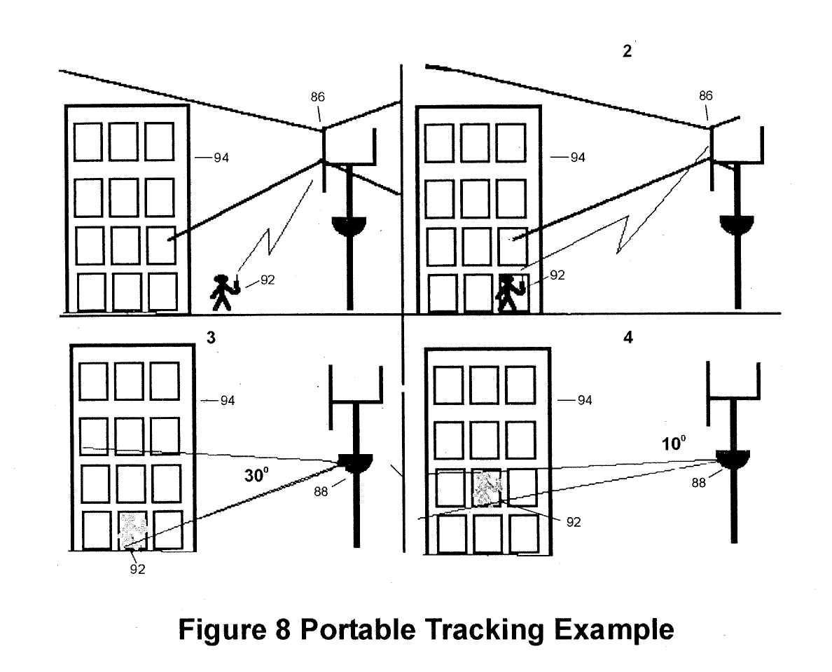

FIG. 8 illustrates in one exemplary embodiment, the method of tracking a mobile user 92 traveling within a building 94 and experiencing a deep fade. As the mobile user 92 enters the building 94, the active antenna system 88 increases the gain by narrowing the beam-width of the active antenna 88. FIG. 8 also illustrates the three dimensional tracking capabilities of the active antenna system 88.

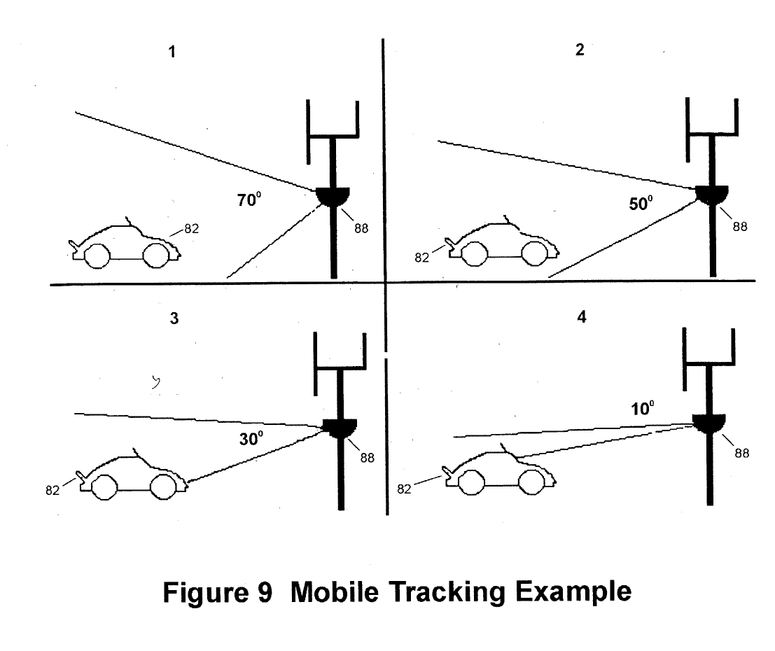

FIG. 9 illustrates another method of tracking a mobile user. As previously discussed, although the active antenna 88 is shown as semi-spherical in shape, the active antenna may be in any shape.

Functional Description

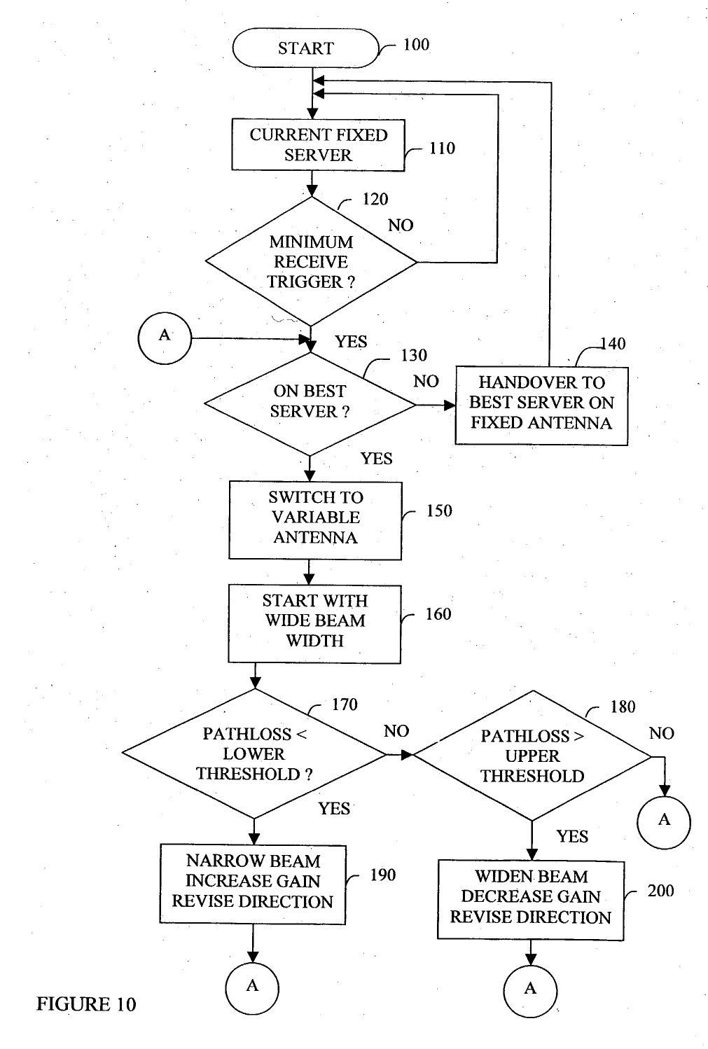

FIG. 10 is a flow chart illustrating the method for adapting the beam width, antenna gain, and the directivity of the variable antenna. The active antenna system 10 and method functions to adapt the radiation pattern to the changes in fading, interference and traffic conditions.

Pathloss

A wireless base station system using an active antenna system 10 can improve the path loss or gain between a mobile user and the base station. The communication link between the transmitter and receiver functions within the parameters of a power budget. The power budget includes the maximum path loss between a transmitter and a corresponding receiver along with the loss or gains from the antenna, transmission lines, splitters, combiners, amplifiers, transmitters, low noise pre-amplifiers, the receive sensitivity and the like. So long as the actual path loss is less than the maximum path loss, a communication link is maintained between the transmitter and the receiver and the call is not dropped. However, if the actual path loss exceeds the maximum path loss, then the antenna system cannot maintain the communication link and the call is subsequently dropped. A path loss calculation is made for each communication link and a corresponding adjustment of the beam width is made to achieve the desired gain needed to maintain the path loss target between the mobile user and the active antenna system.

Operation

The active antenna system 10 may be used in a cellular base station, or mobile station such that the beam width, directivity, and the resulting gain of the antenna is variably adjusted to provide the desired gain and radiation pattern. The pattern is formed in order to provide coverage to a mobile user while the gain is selected in order to provide a communication link. The active antenna system 10 electrically changes it's beam within three dimensional space and tracks the mobile user while the mobile moves as shown in FIGS. 6, 8, and 9. The antenna directivity and centerline position vector (center of beam width originating at the antenna and radiating radially outward from the antenna) is controlled by the base station which tracks the mobile by electrically varying the base station antenna's beam centerline position vector formed radially outward from the antenna. The active antenna system 10 adapts the radiation pattern of the antennas in order to provide the required coverage and path loss for each communication link.

The variable gain antenna method shown in FIG. 10 begins at step 100. The active antenna system 10 seeks to provide a communication link on a fixed gain antenna at step 110. The majority of the calls placed in a wireless system are satisfactorily handled by the fixed gain antenna system. A smaller, but significant number of calls, or portions of a call experiences a deep fade. However, calls experiencing a deep fade are often dropped because these calls cannot be serviced by the fixed antenna system. The deep fade is detected by receiving a trigger indicating that the receive signal strength or the quality of the call such as a bit error rate or frame error rate is below a trigger level at step 120. In one embodiment, calls may be placed on the fixed gain antennas so long as the path loss is less than the maximum allowable path loss. If the pathloss is less than the maximum path loss for the fixed antenna, then, the trigger is not activated and the current fixed server supports the call at step 110. However, if the trigger is activated at step 120, then a best server test is performed at step 130 to determine if another fixed antenna in the system may support the call at step 140 as the best server. In one embodiment, hysterisys may be employed to form an upper and lower hysterisys trigger level to reduce excessive bounce between fixed servers and between fixed and variable antenna servers.

The hybrid fixed and variable antenna system seeks to place calls on a best server with a relatively low path loss on the fixed antenna system rather than on the variable antenna system in order to provide a low cost service to mobile users. The variable antenna system may then service those calls experiencing very deep fades where the path loss exceeds the maximum path loss on the fixed gain antennas. If the actual path loss exceeds the maximum path loss for the fixed antenna, the call may be switched from the fixed gain antenna to the variable can antennas. Since the variable gain antennas have a maximum path loss that exceeds the maximum path loss of the fixed gain antennas, a communication link may be maintained under deep fades that are more severe than may be served with a fixed gain antenna system.

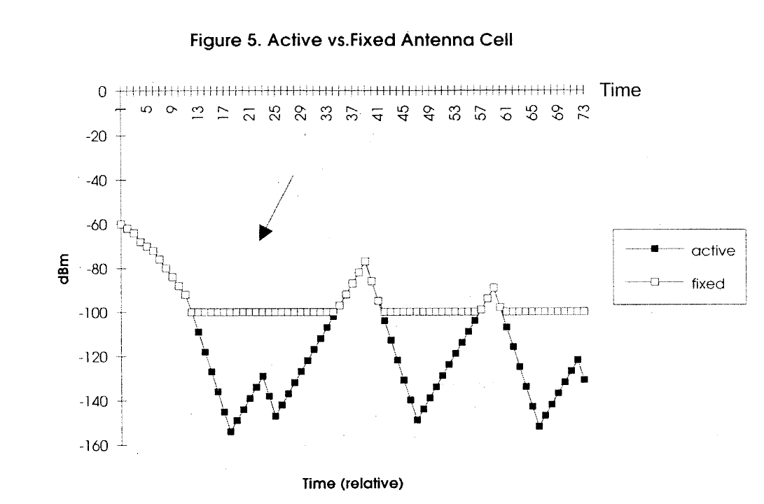

FIG. 5 is a received signal power graph over time illustrating the transition between the fixed antennas and the variable antennas in the hybrid fixed-variable antenna system. As previously stated, if the actual path loss in the communication system exceeds the maximum path loss of the fixed antenna system, then the call is dropped if no other fixed or variable antenna server is available. Therefore, if there is no other fixed server capable of handling the mobile user, then rather than dropping the call, the call may be switched to the variable antenna 60 at step 150. Calls made in the hybrid wireless communication system may be maintained while in a deep fade by switching the call to a variable antenna system from the fixed antenna system.

Mobile Acquisition

Once the initial switch is made from the fixed antenna 60 to the variable beam antenna 70, the mobile undergoes position and power acquisition by starting with a wide beam width, then zooming in on the target mobile by scanning for maximum signal strength and narrowing the beam width if higher gain is required. The mobile acquisition method may determine the position and track the mobile by a maximum search procedure. For example, initially, the variable gain antenna 60 may be configured with a wide beam width at step 160 so that coverage may be provided to the mobile user located anywhere in the coverage area. If the pathloss is less than a lower threshold at step 170, then the path gain may be improved by narrowing the beam-width of the antenna radiation pattern at step 190. Accordingly, the active antenna system 10 can compensate for deep fades commonly encountered by mobile users such as portable mobile telephones in buildings and dense urban environments. Otherwise, deep fades can result in a dropped call. The beam-width and the direction of the antenna radiation pattern may be controlled by the computer controlled mobile tracker 20 for the active antenna system.

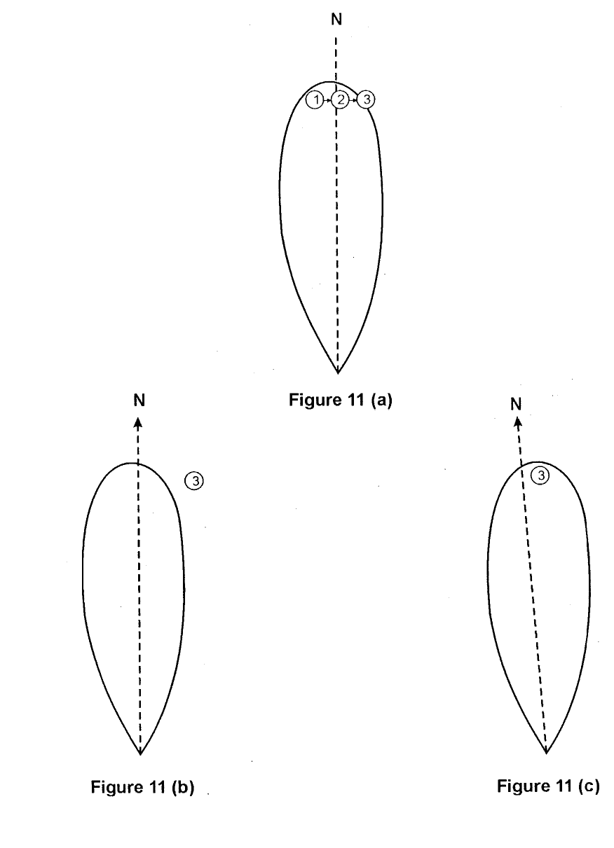

The controller 20 can at steps 190, 200 track the mobile user and adjust the gain of the antenna. For an example of tracking, as shown in FIG. 11(a), if the mobile user is traveling from position (1) to (2) and then to (3), the receive signal strength will decrease as the user moves from the centerline of the beam away to position (3). The mobile tracking controller 20a then alters the centerline of the beam in three dimensions from that shown in FIG. 11(a) with respect to the reference line pointing North. The mobile tracking controller 20(a) may shift the centerline of the beam to the west, east, up or down by an amount equal to the 3 dB beam width for small beam widths and measure the receive signal strength. If the signal strength decreases, then the centerline of the beam width is moved to the east by an amount equal to the 3 dB beam width. If the signal strength increases either to the west or east, then the centerline of the beam is adjusted accordingly for the position providing the highest signal strength. For larger beam widths, the centerline of the beam may be a fraction of the beam width.

In one embodiment, multiple calls may be served by a single active server where the path loss requirements are satisfied for each user. For example, the bandwidth may be widened such that both users are covered by the single active server while maintaining both target pathlosses.

As shown in FIG. 10, if the pathloss exceeds an upper threshold value, then the width of the beam may be increased at step 200 in order to reduce the amount of mobile tracking required. Tracking of the mobile is then performed as described above. In one embodiment, the width of the beam and the power transmitted may be reduced in order reduce the amount of interference in the system so long as the minimum path loss requirements are satisfied.

The main element of the active antenna system 10, such as the phased array or the array of high gain antennas may provide 20 dB to 100 dB of gain depending on its design (based on cost and performance). By contrast, typical fixed gain antennas utilize either omnidirectional 9 dB gain antennas, or 11 dB to 17 dB fixed gain directional antennas. Building penetration loss is typically in the range of 10 dB to 40 dB. Other factors such as building construction and officer furnishings also affect the RF path loss. Therefore, the active antenna system 10 can provide the in-building coverage requirements for an urban service area.

The active antenna system 10 may be used either with or without a convention base station using a conventional fixed antenna. First, the active system tracks the mobile through the system and directs the RF energy to the mobile user in poor coverage areas when conventional base stations provide no coverage. Second, the active antenna system is capable of locating a mobile user in three dimensional space. Third, the high gain active antennas are used when the mobile enters a deep fade. Further, the use of active antennas eliminates the loss in trunking efficiency due to sectorization because the active antennas may serve any location within the base station coverage area.

The active antenna system 10 may be used with or without conventional microcell systems. Microcells attempt to provide improved coverage and capacity in urban environments by increasing the number of base stations in the system and locating them closer to the users of the system. Unfortunately, even when these cells are located inside a building, the path loss inside the building is so great that the useful coverage area is not extended inside the building. In an urban environment, metal structures in buildings and vegetation typically cause the highest levels of attenuation. Active antenna systems can concentrate the RF energy in exactly the right place in both the up link and downlink to compensate the high loss of building structures, vegetation, and the like.

Fewer base station locations are required providing coverage because coverage is improved through the use of the active antennas. Fewer cells sites results in a significant savings in real estate costs. Microcells are relatively expensive because additional real estate is required to support a microcell. Land acquisition is a significant expense of a cellular operator especially in an urban environment. The highly directive active tracking system is superior in coverage and capacity to conventional systems because RF coverage is concentrated only in the areas that are needed. Therefore there is less dependence on real-estate requirements such as cell site location thus providing a cost savings to the operator which may more than offset the cost the additional equipment

CDMA Interference Solution

Conventional microcell technology attempts to provide coverage by saturating the environment with RF energy through out a base station coverage area regardless if a call is in progress or not. This is due to the use of fixed-gain antennas with fixed beam radiation patterns. Radiating energy in an entire base station coverage area is a drawback for cellular operators because of the high levels of interference encountered. Interference is a major cause of problems for system operator optimizers and for the cellular user. Interference is reduced using the active antenna concept because energy is focused only where and when it is needed. Wasted RF energy is not transmitted to areas not requiring coverage and therefore greatly reduces the probability of interference. Interference may be further controlled by the system by ensuring the active antennas are on appropriate re-use channels. The antenna controllers will know when a cell is “beaming” a signal in an area likely to encounter interference. At this point, the antenna controller in coordination with the base station controller may hop frequency via hand-over to another channel.

As a result, a stronger received signal is realized and a lower amount of interference is encountered which results in increased capacity. The resulting increase in C/I (carrier to interference) improves the path-loss margin which results in a much more robust communication link, reduced drop calls, and reduced interference. Therefore, the active system described provides an interference control mechanism and the superior coverage advantage over fixed gain servers, which can make CDMA more feasible. A CDMA base station may use an active antenna system based on any system, independent of the modulation technology used.

The hybrid antenna system may be used with any type of wireless technology such as AMPS, TACS, CDMA, TDMA, and the third generation networks. The hybrid fixed and variable antenna system may be backward compatible with current wireless technology systems.

Channel or PN code assignments may be made dynamically in order to minimize the interference in the system. Under light system traffic, the system may re-configure itself to decrease interference by re-using channels less.

Lower Access Signal Strength Requirements

System operators currently attempt to improve the quality of a cellular call by requiring that the mobile receive signal strength be above an access threshold level before granting access to a mobile. The operator hopes that if the call is initially relatively strong, then there is a good chance the call will continue to be of high quality. The drawback is that the service provides allows fewer calls to be provided access to the system. Since, the active antenna system 10 can tolerate greater pathloss, access can be provided to a mobile that otherwise would be denied access.

Further, once the mobile can access the system with a lower, yet sufficient signal strength, the call quality can be maintained under deep fade conditions. Furthermore, the access requirement may be lowered because even a weak signal sufficient to access the system may immediately be switched to the active antenna system. More calls will be allowed service on the active system because the path gain can be improved over the initial access conditions. This will result in greater revenue for the operator due to the increased number of calls, which can be served with better voice quality than with conventional systems.

Both the coverage and the capacity for the active antenna system 10 and the hybrid system configuration may be improved over a fixed antenna system. At one extreme, for example, a cell may be configured with a large number of active servers in a coverage area. The use of a large number of active antennas provides the most flexible coverage, but at a high cost because due to the cost of the active antenna system. If most of the traffic may be handled by an omni cell, but occasionally the traffic is handled by an active server, then a hybrid antenna system will improve coverage performance at a reasonable cost. Capacity is also improved over a fixed antenna, system because additional servers are provided further improving truncking efficiency.

While the invention has been discussed in terms of preferred and specific embodiments, it should be appreciated by those of skill in the art that the invention is not so limited. The embodiments are explained herein by way of example, and there are numerous modifications, variations and other embodiments that may be employed that would still be within the scope of the present invention.

We claim:

1. A wireless mobile communication system comprising:
a variable beam antenna system having a beam width and a direction;
a variable beam antenna controller for controlling the beam width and direction of the variable beam antenna system and for receiving a communication link quality indication; and
a predetermined trigger for measuring the communication link quality indication in at least one beam width position and positioning the beam width in a direction corresponding with a maximum communication link quality.

2. The wireless mobile communication system of claim 1 wherein the beam is positioned in the group consisting of east, west, up and down.

3. The wireless mobile communication system of claim 1 comprising a fixed gain antenna system wherein the a call is switched from the fixed gain antenna system to the variable beam antenna system when the communication link quality indication exceeds a maximum fixed antenna pathloss.

4. The wireless mobile communication system of claim 1 wherein the predetermined trigger comprises an upper hysterysis trigger and a lower hysterysis trigger.

5. The wireless mobile communication system of claim 1 wherein the predetermined trigger level is a signal strength indication.

6. The wireless mobile communication system of claim 1 wherein the predetermined trigger level is selected from the group consisting of a bit error rate indication, and a frame error rate indication.

7. The wireless mobile communication system of claim 2 wherein measuring the communication link quality occurs at beam width positions of at least one beam width.

8. The wireless mobile communication system of claim 2 wherein measuring the communication link quality occurs at beam width positions of at less than one beam width.

9. A method for providing wireless mobile communications, the steps comprising:
selecting a beam width and direction for a variable beam antenna system;
receiving a communication link quality indication;
selecting a predetermined trigger for measuring the communication link quality indication in at least one beam width position; and
positioning the beam width in a direction corresponding with a maximum communication link quality.

10. The method of claim 9, wherein the beam is positioned in the group consisting of east, west, up and down.

11. The method of claim 9 wherein a call is switched from a fixed gain antenna system to the variable beam antenna system when the communication link quality indication exceeds a maximum fixed antenna pathloss.

12. The method of claim 9 wherein the predetermined trigger comprises an upper hysterysis trigger and a lower hysterysis trigger.

13. The method of claim 9 wherein the predetermined trigger level is a signal strength indication.

14. The method of claim 9 wherein the predetermined trigger level is selected from the group consisting of a bit error rate indication, and a frame error rate indication.

15. The method of claim 9 wherein measuring the communication link quality occurs at beam width positions of at least one beam width.

16. The method of claim 9 wherein measuring the communication link quality occurs at beam width positions of at less than one beam width.
